(19) United States
(12) Patent Application Publication
(10) Pub. No.: US 2006/0143023 A1
(43) Pub. Date: Jun. 29, 2006

(54) Questionnaire software module

(76) Inventor: David Gillespie, Cannon Hill (AU)

Correspondence Address: EDWIN D. SCHINDLER, FIVE HIRSCH AVENUE, P.O. BOX 966, CORAM, NY, 11727-0966, US

(21) Appl. No.: 10/560,040

(22) PCT Filed: Mar. 9, 2004
(86) PCT No.: PCT/AU04/00290

§ 371 Date: Feb. 21, 2006

(30) Foreign Application Priority Data
Mar. 7, 2003 (AU) 2003901036

(51) Int. Cl. G06Q 99/00; G06F 15/02; G06F 9/46

(52) U.S. Cl. 705/1; 705/9

(57) ABSTRACT

A software questionnaire module, which is adapted for use online, permits a questionnaire to be electronically distributed, monitors deadlines and effects reminders, when necessary, and automatically collates and distributes results of a questionnaire to relevant users of the module.

### AREA OF THE INVENTION

This invention relates to the area of corporate governance software and in particular to software for use by businesses and corporations to automate their conduct of questionnaires.

### BACKGROUND TO THE INVENTION

It has been customary in the corporate environment for any questionnaires which are required to be carried out as part of the business management to be in paper form. The questionnaire is first devised, then physically distributed, then returned and physically collated and distributed to relevant personnel. Alternatively email may be used to effect distribution and to remind respondents of deadlines and the like.

This is clearly a clumsy procedure and in a current environment tending more towards office automation is an anachronistic approach to information gathering and dissemination within a corporate environment.

### OUTLINE OF THE INVENTION

It is an object of this invention to provide questionnaire software which is able to replace the manual approach described above and to provide questionnaire software which is able to interact with and provide an adjunct to compliance management software including meeting management software.

The invention is a software questionnaire module which is adapted to be used online and permits a questionnaire to be distributed electronically, monitors deadlines and effects reminders where necessary and automatically collates and distributes results of a questionnaire to relevant users of the module.

It is preferred that the module be menu based and that menus be accessible to the users required to answer the questionnaire as well as the questionnaire authors.

For example where the term questionnaire appears on the menu, selecting that item will display all questionnaires which that user is entitled to access. Respondents will see only questionnaires that they are authorised to see whereas authors can also see those that they have authored.

From this screen a respondent can open a questionnaire and answer it. An author can either respond to a questionnaire or edit it or view the responses and run general reports.

### CREATING THE QUESTIONNAIRE

The author creating the questionnaire can define the title, description and due date of the questionnaire as well as list the questions as well as which users are to respond to any questions. In addition ad hoc questions can be created or imported.

It is also preferred that a certification statement be defined which is displayed when a user submits and certifies that what has been answered is correct. The author can keep the questionnaire as a draft and open to modification however it is preferred that no further modification be possible once the questionnaire has been published.

It is preferred that once the questionnaire is complete that email notifications be automatically sent to each user when it is available for viewing, when it is published and also when it is near its due date to act as a reminder if the questionnaire has not been adequately responded to.

Typically a view responses screen is provided to an author from which screen a series of questionnaire reports can be run to establish its current status. The arrangement is such that the author can view individual respondents responses to date as well as a consolidated summary of various responses.

It is preferred that a total summary of a questionnaire provide a list of negative and non applicable responses sorted by question and user for all users. The reason or comment is also displayed. A summary for each user can also be generated which only displays negative and N/A responses to questions for the selected user. Alternatively the author can choose to run custom reports based on groups of users. Such a custom report can be provided by selecting a list of users whose responses are consolidated.

It is further preferred that an audit trail be generated for all users or a selected user only. It includes all actions on the questionnaire such as the creation and publishing of the questionnaire. It therefore provides an audit trail of who completed which questions at which time or it can provide only the level of audit required. The author can choose to run a log report for all actions that have occurred by all users or can restrict the report to specific actions and users. The actions include the following:
creating a draft of the questionnaire
editing a draft of the questionnaire
providing preview ability to the questionnaire
publishing the questionnaire
answering a question
answering yes to a question
answering no to a question
answering N/A to a question
specifying a reason for a negative of N/A response
specifying a conclusion to the questionnaire

Finally, if an author is dissatisfied with the questionnaire response of any user the response can be rejected, which generates an email notification to the users to refill out the response. As part of the rejection process the author may specify the reasons why the response is being rejected and these reasons will be included in the email.

All users are required to submit their answers to the questions within the various questionnaires they have been assigned to. A link to their individual questionnaire will be sent via email and be accessible to the meeting management system.

A questionnaire may typically require more than one sitting to complete. Users may therefore answer the questions and save the questionnaire as a work in progress. When an assistant has submitted the questionnaire an email will be generated notifying the user. It is preferred that a compulsory reason be given by a user to any negative or N/A answer before a user is able to submit the questionnaire.

Once the user has submitted the questionnaire the user will be immediately asked to certify that what has been answered is accurate. This process allows the certifier to lodge a document such as a scanned signature as proof that the questionnaire has been certified.

In order that the invention may be more readily understood we shall describe by way of non limiting example a particular embodiment of the invention.

### EXAMPLE OF AN EMBODIMENT OF THE INVENTION

An example of an embodiment of the invention is a flat questionnaire, although this is not an essential feature of the invention, in which one body constructs and manages the questionnaire. This body publishes it to anyone in the relevant organisation thereby bypassing any hierarchical parent structure as shown in the following diagram.

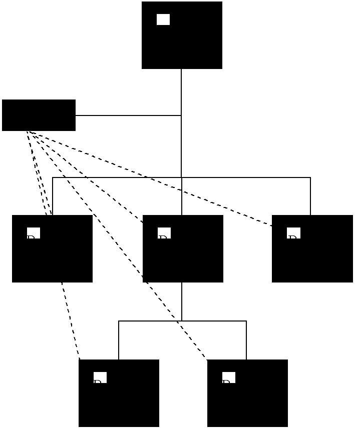

Some examples of possible business rules are given below:

Scenario one
The first example shows that a person can belong to multiple ‘groups’ and
that they might be required answer the same question for each group
to which they belong. It also shows that multiple people in a group
may be asked to answer the same question.

| | | Professional |
|---|---|---|
| Question | R&D | services |
| Q1. All staff have filled out their timesheets | David | Rob |
| and expense reports | Rob | |
| | Phil | |
| Q2. DME 9 functional specification completed | Phil | |
| | David | |
| Q3. Are all customer support issues closed? | | Rob |
| | | Maciek |

Another way to Illustrate the same thing is:

| Question | David | Rob@RD | Rob@PS | Phil | Maciek |
|---|---|---|---|---|---|
| Q1. All staff have | Y | Y | Y | Y | |
| filled out their | | | | | |
| timesheets and | | | | | |
| expense reports | | | | | |
| Q2. DME 9 functional | Y | | | Y | |
| specification | | | | | |
| completed | | | | | |
| Q3. Are all customer | | | Y | | Y |
| support issues | | | | | |
| closed? | | | | | |

Scenario two
This scenario attempts to determine if there is a requirement to have multiple types of groups.

| | R&D | | | Professional Services | | |
|---|---|---|---|---|---|---|
| Question | DME | Retriever | Discovery | DME | Retriever | Discovery |
| Q1. Dev of latest version on | Rob | Rob | Rob | | | |
| target? | Richard | Martyn | Andrew | | | |
| Q2. Budget of latest version | Rob | Rob | Rob | | | |
| on target? | | | | | | |
| Q3. Roll outs on budget? | | | | Rob | Matthew | |
| | | | | Maciek | | |

From these scenarios we can determines some rules.

Business Rules

Need to report on a group level. For a Corporate compliance questionnaire, this grouping will be by Business unit.

Zero to N (0 . . . n) people In each group may be required to answer a particular question.

A person can belong to multiple groups If this is so, it must be clear to the person which group they are answering for. This could be achieved by presenting the user with 2 separate questionnaires. For example, Rob from scenario 1 above logged on his main screen could include a table like this:

| Questionnaire | Group | Due |
|---|---|---|
| Weekly Report for | R&D | 16/12/2002 |
| week ending 14/12 | | |
| Weekly Report for | Professional Services | 16/12/2002 |
| week ending 14/12 | | |

Ultimately (i.e. not In first version) there might be multiple types of groups. For example, the second scenario above has both Business Unit groups and Project groups.

Data Structures

In order to be able to report on groups and store the data there are 3 types of data to be stored: Questions, People and Groups.

In order for the many to many relationships to be Implemented as discussed above the table structure would be something like:

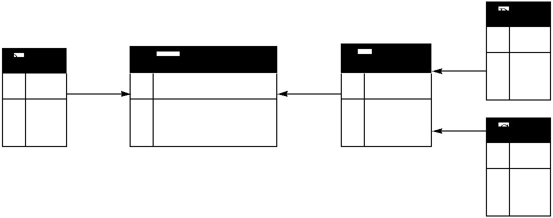

Alternatively, a less normalized version might be:

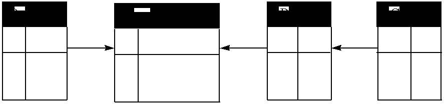

In this case if a real person belonged to multiple groups they would have multiple Person records.
Business Process

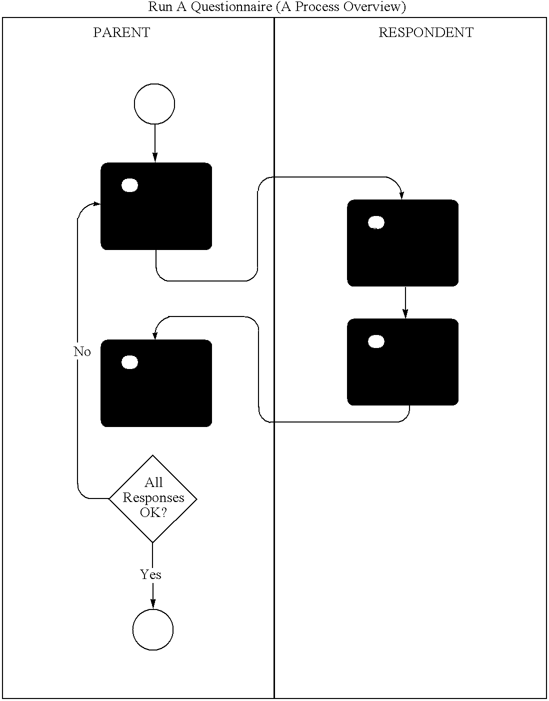

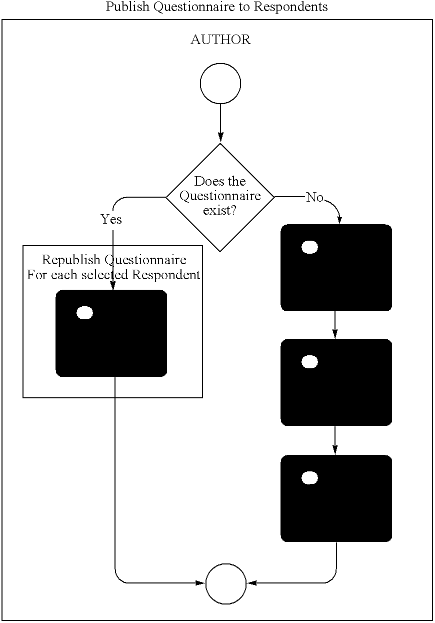

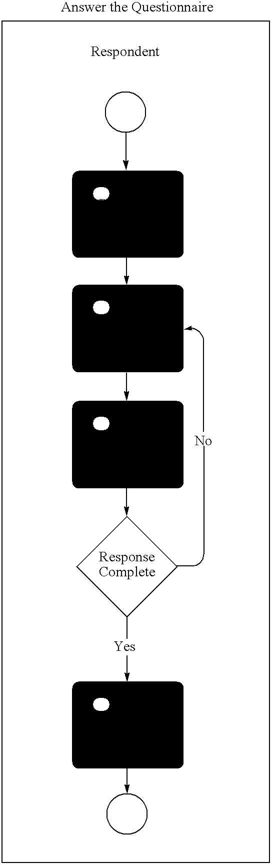

While we have described herein one particular embodiment of the invention it is to be understood that variations and modifications in the materials used and the features described can still lie within the scope of the invention.

1-12. (canceled)

13. A software questionnaire module for online use, comprising:
means for electronically distributing a questionnaire;
means for monitoring deadlines for responding to said questionnaire;
means for effecting reminders of said deadlines for responding to said questionnaire; and,
means for distributing results of said questionnaire to select users of said software questionnaire module.

14. The software questionnaire module for online use according to claim 13, further comprising at least one menu accessible to users required to answer said questionnaire.

15. The software questionnaire module for online use according to claim 14, wherein said at least one menu is accessible to authors of said questionnaire.

16. The software questionnaire module for online use according to claim 14, wherein said at least one menu includes means for selecting a plurality of questionnaires to which said users are entitled to access.

17. The software questionnaire module for online use according to claim 13, further comprising means for allowing a respondent of said questionnaire to access said questionnaire and respond to said questionnaire on a display screen.

18. The software questionnaire module for online use according to claim 13, further comprising means for permitting an author of said questionnaire to either respond to said questionnaire, edit said questionnaire or view responses to said questionnaire.

19. The software questionnaire module for online use according to claim 13, further comprising means for permitting respondents to access said questionnaire only with authorization to do so and means for permitting an author of said questionnaire to also access all said questionnaires said author has written.

20. The software questionnaire module for online use according to claim 13, further comprising means for permitting an author of said questionnaire to define a title, a description and a due date for said questionnaire.

21. The software questionnaire module for online use according to claim 20, further comprising means for permitting said author of said questionnaire to list questions.

22. The software questionnaire module for online use according to claim 20, further comprising means for permitting said author of said questionnaire to specify which persons are to respond to said questionnaire.

23. The software questionnaire module for online use according to claim 13, further comprising means for automatically notifying said select users when said questionnaire is complete, means for informing when said questionnaire is available for viewing and means for informing when said questionnaire is approaching its due date.

24. The software questionnaire module for online use according to claim 13, further comprising a summary for said questionnaire.

25. The software questionnaire module for online use according to claim 13, further comprising means for permitting an author to run customized reports based upon a group of users.

26. The software questionnaire module for online use according to claim 13, further comprising means for generating an audit trail for said questionnaire.

27. The software questionnaire module for online use according to claim 13, further comprising means for permitting an author of said questionnaire to provide any respondent to said questionnaire with an e-mail notification advising said any respondent that said author is dissatisfied with answers provided to said questionnaire and that said any respondent should again answer said questionnaire
